(19) United States
(12) Patent Application Publication
(10) Pub. No.: US 2009/0093945 A1
(43) Pub. Date: Apr. 9, 2009

(54) Controller and control system for internal combustion engine

(75) Inventor: Hiroshi Okumura, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/232,855

(22) Filed: Sep. 25, 2008

(30) Foreign Application Priority Data
Oct. 5, 2007 (JP) 2007-262053

(51) Int. Cl. F02D 45/00

(52) U.S. Cl. 701/103; 123/672

(57) ABSTRACT

An alcohol sensor detects alcohol concentration of a fuel stored in a fuel tank. When an internal combustion engine is started, a start timing of heating a sensor element by a heater is variably set based on the alcohol concentration.

### CROSS-REFERENCE TO RELATED APPLICATION

This application is based on Japanese Patent Application No. 2007-262053 filed on Oct. 5, 2007, the disclosure of which is incorporated herein by reference.

### FIELD OF THE INVENTION

The present invention relates to a controller for an internal combustion engine and a control system for an internal combustion engine equipped with the controller. A heating means heats an exhaust gas sensor detecting a property of the exhaust gas so as to activate the exhaust gas sensor.

### BACKGROUND OF THE INVENTION

In an internal combustion engine for a vehicle, it is well known that air-fuel-ratio feedback control is performed in order to reduce the emission. A three-way catalyst disposed in an exhaust pipe exerts an exhaust gas purification capacity in a specified air-fuel ratio. The air-fuel-ratio feedback control is performed so that the actual air-fuel ratio becomes a desired value in which the three-way catalyst achieves the high performance. The actual air-fuel ratio is obtained as a detected value of an air-fuel-ratio sensor which is disposed in an exhaust gas and detects its air-fuel ratio based on specified components of the exhaust gas. Usually, the air-fuel-ratio sensor is provided with a sensor element made of ceramic. When the sensor element is activated, the air-fuel ratio can be detected. In order to activate the sensor element early, the air-fuel-ratio sensor is heated by a heater.

At starting of the engine, the engine temperature is relatively low, and the saturated vapor pressure of gas in the exhaust pipe is relatively low. Hence, in such a situation, moisture vapor in the gas flowing through the exhaust pipe may be condensed and the condensed water may adhere on an inner wall of the exhaust pipe. Further, in this case, an energization of the heater may cause a thermal shock to generate a crack in the sensor element of the air-fuel-ratio sensor. JP-2004-360563A shows that a heater energization start time is established based on parameters which have correlation with the engine temperature.

In recent years, an internal combustion engine and an engine control system which use alcohol (ethanol) as fuel have been developed. In a vehicle called a flexible fuel vehicle (FFV) equipped with such a system, only ethanol can be used as well as a fuel mixture of gasoline and ethanol. That is, the ethanol concentration of the fuel used for the FFV varies from 0% to 100%.

In a case that ethanol is combusted, the moisture vapor quantity is increased, compared with a case that gasoline is combusted. Hence, when the fuel includes ethanol and the heater, is energized at the same timing as the case where the fuel is only gasoline, the heater may be energized under a condition where the condensed water still adheres to an inner surface of the exhaust pipe.

### SUMMARY OF THE INVENTION

The present invention is made in view of the above matters, and it is an object of the present invention to provide a controller and a control system for an internal combustion engine, which is capable of activating the exhaust gas sensor by heating with a heating means even if a various kinds of fuel is used.

According to the present invention, an internal combustion engine is equipped with an exhaust gas sensor which detects a property of an exhaust gas. The exhaust gas sensor is activated by receiving a heat from a heating means. A controller for the internal combustion engine includes a concentration obtaining means for obtaining a concentration information with respect to a concentration of a specified component of a fuel, and a set means for variably setting a heating start time of the heating means based on the concentration obtained by the concentration obtaining means.

A vapor quantity in the exhaust gas varies according to a chemical component of the fuel supplied to the internal combustion engine. Hence, an adhering tendency of a condensed water to an inner surface of an exhaust pipe varies according to the chemical component of the fuel at starting of the engine. A period in which the heating means can heat the exhaust gas sensor without a deterioration of a reliability of the sensor varies according to the fuel component. According to the present invention, since the heating start time is variably set according to a concentration of a specified component of the fuel, the exhaust gas sensor is properly heated to be early activated.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing an entire structure of an engine control system according to a first embodiment;

FIG. 2 is a flow chart showing a process of a heater energization starting control according to the first embodiment;

FIG. 3 is a flow chart showing a process of an alcohol concentration estimation according to a second embodiment; and

FIG. 4 is a flow chart showing a process of a heater energization starting control according to a second embodiment.

### DETAILED DESCRIPTION OF EMBODIMENTS

### First Embodiment

Hereinafter, a first embodiment of the present invention will be described with reference to the drawings.

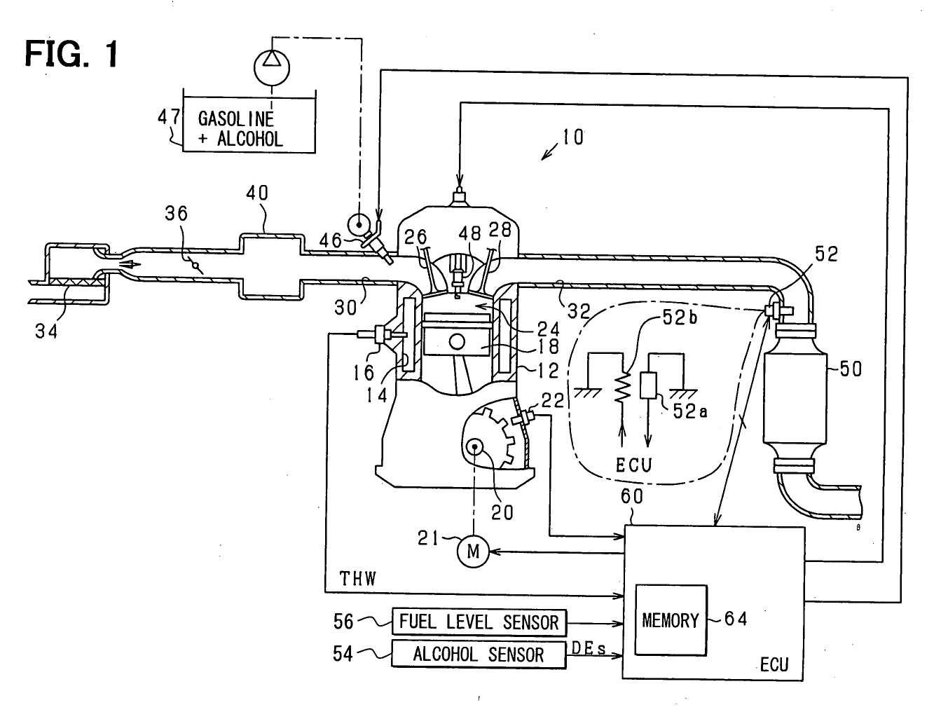

FIG. 1 shows an entire structure of an engine control system in the first embodiment. A multi-cylinder engine (for example, an inline four-cylinder engine) for a 4-wheel automobile is assumed as an internal combustion engine 10 of this embodiment. FIG. 1 shows only one cylinder for explanation. Moreover, as shown in the FIG. 1, the internal combustion engine 10 is a spark ignition type internal combustion engine of the inlet-port-injection type of 4 strokes.

In the internal combustion engine 10, the cylinder is formed in a cylinder block 12. A cooling channel (water jacket 14) for circulating a coolant inside of the internal combustion engine 10 is formed in the cylinder block 12, and the internal combustion engine 10 is cooled by the coolant. Moreover, the water temperature sensor 16 which detects the temperature of the coolant (cooling water temperature) in the water jacket 14 is provided in the cylinder block 12. Furthermore, a piston 18 is accommodated in each cylinder and the output shaft (crankshaft 20) of the internal combustion engine 10 rotates by reciprocation of the piston 18. A starter 21 which gives an initial rotation to the engine 10 is connected with the crankshaft 20. The crankshaft 20 is provided with a crank angle sensor 22 for outputting a crank angle signal at intervals of a specified crank angle (for example, at intervals of 30° C.A) so as to detect the rotational angle position and the rotation speed of the crankshaft 20.

A cylinder head is fixed on an upper surface of the cylinder block 12. A combustion chamber 24 is defined by the cylinder block 12, the cylinder head, and the upper surface of the piston 18. The cylinder head is provided with an intake port and an exhaust port. These intake port and the exhaust port are respectively opened/closed by an intake valve 26 and an exhaust valve 28 which are driven by a cam (not shown) attached to the camshaft interlocked with the crankshaft 20. Moreover, an intake pipe 30 for intake fresh air is connected to the intake port of each cylinder. An exhaust pipe 32 for discharging combustion gas (exhaust gas) from each cylinder is connected to the exhaust port.

The fresh air is introduced into the intake pipe 30 through an air cleaner 34. A throttle valve 36 is provided downstream of the air cleaner 34. The throttle valve 36 is electrically driven by an actuator such as a DC motor. A surge tank 40 is provided downstream of the throttle valve 36 in order to restrict a suction pulse and an intake-air interference.

The intake pipe 30 is branched downstream of the surge tank 40 so that fresh air is introduced into each cylinder. A fuel injector 46 is provided to each intake pipe 30 to inject fuel near the intake port of each cylinder. The fuel injector 46 is an electromagnetic driven type valve or a piezo driven type valve. The fuel stored in a fuel tank 47 is injected to each intake port through each fuel injector 46. The air-fuel mixture which is introduced into the combustion chamber 24 is ignited by a spark plug 48 and is combusted therein.

A three-way catalyst 50 which purifies CO, HC, NOx in the exhaust gas is provided in the exhaust pipe 32. An air-fuel-ratio sensor 52 is provided upstream of the catalyst 50. The air-fuel-ratio sensor 52 detects air-fuel ratio of the air-fuel mixture in the combustion chamber 24 based on concentration of oxygen and unburned fuel in the exhaust gas. The air-fuel-ratio sensor 52 includes a sensor element 52a and a heater 52b. The sensor element 52a is made of solid electrolyte, such as zirconia (ZrO₂), and the heater 52b heats the sensor element 52a. A tip of the sensor element 52a is a sensing portion, which is covered by an outside cover and an inside cover (not shown). The sensor element 52a is formed on a substrate made of alumina (Al₂O₃) along with a gas-shielding layer and a diffusion resistance layer. A predetermined voltage is applied to the sensing portion which is sandwiched by a pair of electrodes. When the heater 52b is energized, the heater 52b generates heat. The heater 52b is embedded in the substrate in such a manner that the sensing portion of the sensor element 52a is directly equally heated. If necessary, a plurality of heaters are embedded. The outside cover and the inside cover are provided with a plurality of air holes through which exhaust gas is introduced inside of the inside cover. The oxygen concentration of the exhaust gas inside of the inside cover is detected by the sensor element 52a. In this air-fuel-ratio sensor 52, the air holes forms labyrinth between the outside cover and the inside cover, so that water resistance of the sensor element 52a is enhanced.

The air-fuel-ratio sensor 52 is used under a condition where at least sensing portion of the sensor element 52a is heated to an operation temperature range (for example, about 700° C.) by the heater 52b. The operation temperature range of the air-fuel-ratio sensor 52 is defined in such a manner as to be greater than an activation temperature of the sensor element 52a without any damage to the sensor element 52a.

The vehicle (not shown) is provided with various sensors, such as an alcohol sensor 54 which detects alcohol concentration in the fuel stored in the fuel tank 47 and a fuel level sensor 56 which detects fuel quantity remaining in the fuel tank 47. The alcohol sensor 54 includes a pair of platinum electrodes which are arranged in the fuel in the fuel tank 47. The electric resistance is varied according to the alcohol concentration, so that the alcohol sensor 54 varies its output voltage according to the alcohol concentration. Alternatively, the alcohol sensor 54 may be a capacitance type sensor.

An electronic control unit (ECU) 60 is structured mainly of a microcomputer and is provided with a non-volatile memory 64. The non-volatile memory 64 can store the memory data without respect to a condition of ignition switch of the engine 10. Specifically, the non-volatile memory 64 is a backup RAM or an EEPROM. The ECU 60 controls the throttle valve 36, the fuel injector 46 and the like based on the signals from the sensors and demands of driver, so that the engine 10 is operated in an optimum condition.

Especially, the ECU 60 detects actual air-fuel ratio and feedback controls the actual air-fuel ratio to a stoichiometric ratio (≈14.8) in which the catalyst 50 performs high purification capacity. Furthermore, the ECU 60 controls electricity applied to the heater 52b so that the temperature of the sensor element 52a becomes a desired value (target value). In a case of starting the engine 10, moisture vapor in the exhaust gas may be condensed and the condensed water may adhere on an inner wall of the exhaust pipe 32. Hence, the heater 52b starts heating of the sensor element 52a when the condensed water is not generated.

In this embodiment, not only the gasoline but the alcohol is permitted as a fuel for the internal combustion engine 10. That is, the vehicle is a flexible fuel vehicle (FFV). In combusting alcohol fuel as compared with the case where gasoline fuel is combusted, at the time of starting the engine 10, the condensed water easily adheres to the exhaust pipe 32. An appropriate time of starting the energization of the heater 52b depends on whether the fuel is gasoline or alcohol and on a mixing rate of gasoline and alcohol. In this embodiment, the energization start time of the heater 52b is variably adjusted according to the alcohol concentration in the fuel.

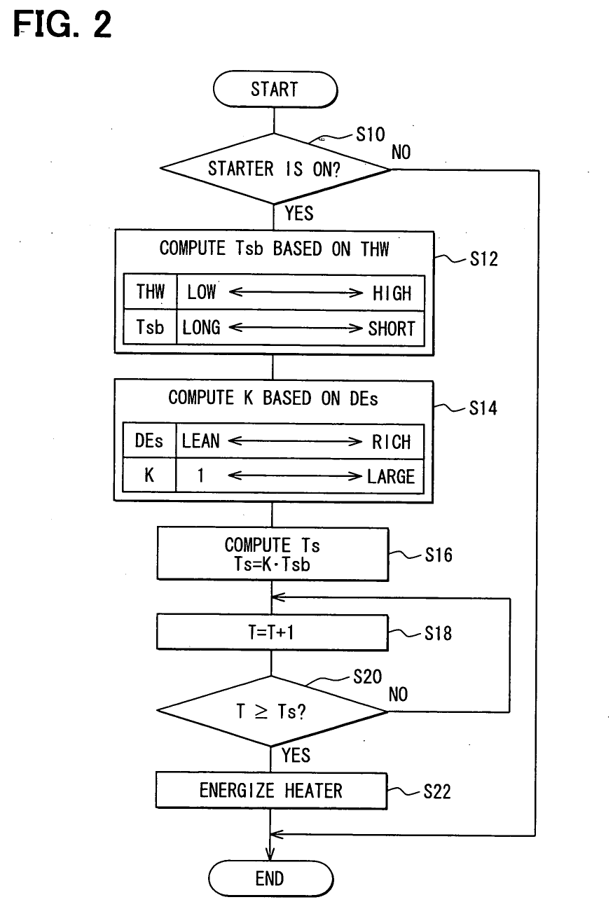

Referring to FIG. 2, a process of a heater energization starting control will be described, hereinafter. This process is repeatedly performed at a specified period by the ECU 60.

In step S10, the computer determines whether the starter 21 is energized. That is, the computer determines whether the engine 10 has just started, and defines a starting time of a combustion control period of the engine 10. When the answer is Yes in step S10, the procedure proceeds to step S12 in which an energization start base time Tsb of the heater 52b is computed based on the coolant temperature THW. In a case that the fuel is gasoline only, this energization start base time Tsb is established according to the combustion control period until the heater 52b is energized. Specifically, the energization start base time Tsb is established as short as possible in a period in which there is no possibility that the condensed water adheres to the exhaust pipe 32, so that the air-fuel ratio sensor 52 can be early activated. This base time Tsb depends on a parameter which has a correlation with saturated vapor pressure in the exhaust pipe 32. The saturated vapor pressure is defined according to a warming-up condition of the engine 10. Hence, the energization start base time Tsb is established by use of the coolant temperature THW as the parameter which indicates the warming-up condition of the engine 10.

In step S14, a correction coefficient K for correcting the energization start base time Tsb is computed based on a detected value DEs of the alcohol sensor 54. When the fuel includes alcohol, the combustion control period until the energization of the heater 52b is varied. The correction coefficient K compensates this variation. As the alcohol concentration becomes higher, the correction coefficient K becomes larger. When the alcohol concentration is zero, the correction coefficient K is “1”. It is desirable that the correction coefficient K is defined so that the energization start base time Tsb is established as short as possible, whereby the air-fuel ratio sensor 52 can be early activated. In step S16, the computer computes a heater energization start time Ts. The energization start time Ts is computed by multiplying the based time Tsb by the correction coefficient K.

In step S18, an elapsed time T after the starter 21 is energized is computed. This processing is for grasping the time after the combustion control of the internal combustion engine 10 is performed. That is, considering that the time from the energization of the starter to the fuel injection is substantially constant, the time T represents an elapsed time after the combustion control is started. In step S20, the computer determines whether the time T exceeds the energization start time Ts. This process is for determining whether it is a situation where no condensed water adheres to the exhaust pipe 32. When the answer is Yes in step S20, the procedure proceeds to step S22 in which the heater 52b is energized.

When the process in step S22 is completed, or when the answer is No in step S10, the procedure ends once.

According to the embodiment described above, following advantages can be obtained.

(1) Based on the alcohol concentration in the fuel, the heating start time (energization start time) of the sensor element 52a by the heater 52b is variably established. Thereby, the sensor element 52a is preferably heated to be early activated with optimum time without any damage to the sensor element 52a.

(2) Based on the alcohol concentration, the air-fuel-ratio sensor 52 is heated. Since an active temperature range of the air-fuel-ratio sensor 52 is very high relative to room temperature, the heater 52b can expedite the activation of the air-fuel-ratio sensor 52.

### Second Embodiment

A second embodiment will be described hereinafter, focusing on a difference from the first embodiment.

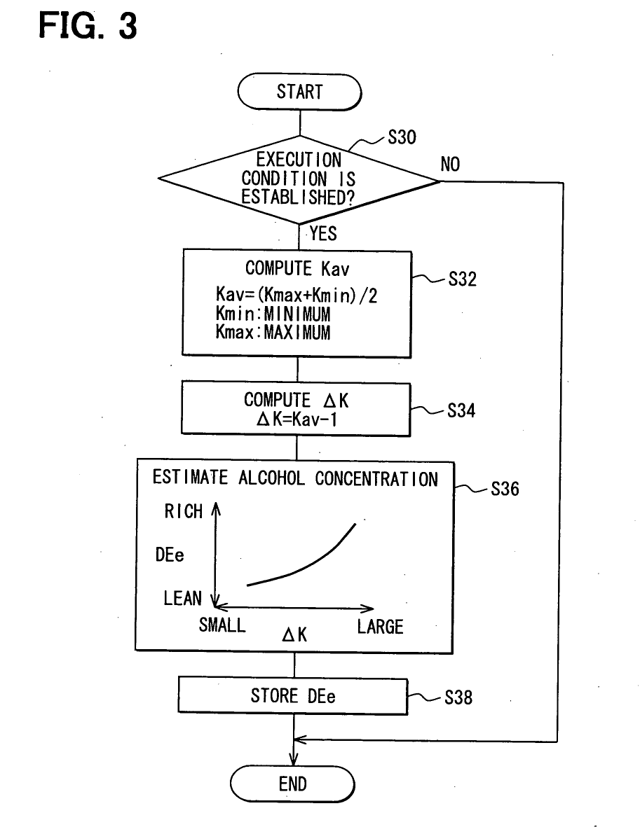

In this embodiment, there is no hardware which directly detects the alcohol concentration. The alcohol concentration is estimated based on a detected value by the air-fuel-ratio sensor 52. FIG. 3 is a flowchart showing an alcohol concentration estimation process.

In step S30, the computer determines whether an execution condition for estimating the alcohol concentration is established. The execution condition is established when the air-fuel-ratio feedback control is performed, or when the coolant temperature THW is greater than a specified value. When the answer is Yes in step S30, the procedure proceeds to step S32 in which an average value Kav of an air-fuel-ratio feedback correction coefficient Kaf is computed. This process is for quantifying a deviation of the detected value of the air-fuel ratio from the target air-fuel ratio. Specifically, an average value of a maximum value Kmax and a minimum value Kmin of the coefficient Kaf which fluctuates above and below is computed.

In step S34, the computer computes a deviation degree ΔK of the air-fuel ratio. The deviation degree ΔK is computed by subtracting “1” from the average value Kav. In step S36, the alcohol concentration is estimated based on the deviation degree ΔK. As shown in FIG. 3, as the deviation degree ΔK becomes larger, that is, as the detected value of the air-fuel ratio deviates in a lean side, the estimated alcohol concentration DEe becomes higher. In step S38, the estimated alcohol concentration DEe is stored in the memory 64. When the process in step S38 is completed, or when the answer is No in step S30, the procedure ends once.

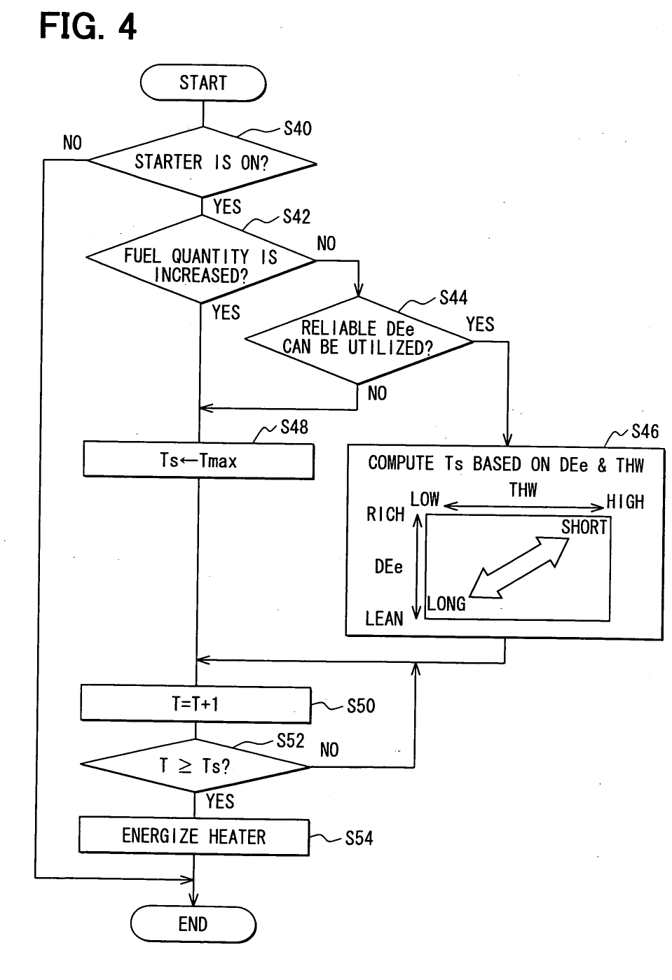

Referring to FIG. 4, a process of a heater energization starting control will be described, hereinafter. This process is repeatedly performed at a specified period by the ECU 60.

In step S40, the computer determines whether the starter 21 is energized. When the answer is Yes in step S40, the procedure proceeds to step S42. In step S42, the computer determines whether fuel quantity in the fuel tank 47 is increased based on the detected signal from the fuel level sensor 56. This process is for evaluating a reliability of the estimated alcohol concentration DEe. That is, when the fuel stored in the fuel tank has been increased, it is considered that the fuel is supplied to the fuel tank 47 after the last stop before the present start of the engine 10. In this case, there is possibility that the component ratio of the fuel in the fuel tank 47 may be changed and the estimated alcohol concentration may deviate from the actual alcohol concentration.

When the answer is No in step S42, the computer determines that there is no deterioration in reliability of the estimated alcohol concentration DEe. The procedure proceeds to step S44. In step S44, the computer determines whether highly reliable estimated alcohol concentration DEe can be utilized. As a factor of deteriorating the reliability of the estimated concentration DEe, it is noted that the air-fuel-ratio sensor has malfunction and the alcohol concentration can not be estimated. The reliability of the estimated concentration DEe stored in the memory 64 may be deteriorated. The memory 64 stores mirror data of the estimated concentration DEe to evaluate the reliability of the estimated concentration DEe.

When the answer is Yes in step S44, the procedure proceeds to step S46. In step S46, the computer computes the energization start time Ts based on the coolant temperature THW and the estimated concentration DEe by use of a map defining a relationship between the coolant temperature, the alcohol concentration and the energization start time Ts. When the answer is Yes in step S42 or when the answer is No in step S44, the procedure proceeds to step S48. In step S48, a maximum time Tmax is set as the energization start time Ts. Thereby, the heater 52b is not energized in a situation that the condensed water adheres to the exhaust pipe 32 without respect to the alcohol concentration. It is desirable that the energization period of the heater 52b is as short as possible in a situation that the condensed water adheres to the exhaust pipe 32. The maximum time Tmax may be a maximum value of the energization start time Ts which is defined by the map used in step S46. Alternatively, the maximum time Tmax is a maximum value of the energization start time Ts at a current coolant temperature THW.

Steps S50-S54 are the same processes as steps S18-S22 in FIG. 2.

According to the second embodiment, following advantages can be obtained besides the above advantages (1)-(2).

(3) The alcohol concentration was estimated based on the parameter (air-fuel-ratio feedback correction coefficient Kaf) which has the correlation with the fuel combustion in the internal combustion engine 10. Thereby, the alcohol concentration can be estimated by the air-fuel-ratio sensor 52, which is a detection means used for combustion control, without an increment of parts.

(4) When it was determined that a reliable value of the alcohol concentration can not be used, the heater energization start time Ts is established as the maximum time Tmax. Thereby, irrespective of the alcohol concentration, the heater is energized without deteriorating the reliability of the air-fuel-ratio sensor 52.

(5) When the computer determines that the fuel is supplied to the fuel tank after the last stop before present start of the engine 10, the heater energization start time Ts is established as the maximum time Tmax. Thereby, irrespective of the alcohol concentration, the heater is energized without deteriorating the reliability of the air-fuel-ratio sensor 52.

### Other Embodiments

The above-mentioned embodiments may be modified as follows:

In the first embodiment, the heater energization start time Ts may be computed by use of a map which shows a relationship between the coolant temperature THW, the alcohol concentration DEs, and the heater energization start time Ts.

In the second embodiment, the energization start base time Tsb may be computed based on the coolant temperature THW and the energization start base time Tsb may be corrected by the estimated alcohol concentration DEe.

In the second embodiment, when it is determined that the fuel is supplied to the fuel tank 47, or when it is determined that the reliable estimated alcohol concentration DEe can not be used, the heater energization start time Ts is set to the maximum time Tmax. Alternatively, the estimated alcohol concentration DEe stored in the memory 64 may be compulsorily rewritten to the maximum concentration (for example, 100%).

The heater energization start time Ts may be defined as a required time from a fuel injection to the energization of the heater 52b.

The estimation method of the alcohol concentration is not limited to the method shown in the second embodiment. For example, the alcohol concentration may be computed based on a ratio between an air-fuel ratio which is computed based on the intake air quantity and the fuel injection quantity and an air-fuel ratio which is detected by the air-fuel-ratio sensor 52. As the ratio becomes larger, the alcohol concentration becomes higher.

The heater energization start time may be established based on a gasoline concentration and the coolant temperature THW.

The way of determining whether the fuel is supplied to the fuel tank 47 is not limited to the way shown in the second embodiment. For example, it can be determined whether the fuel is supplied to the fuel tank 47 based on whether a fuel fill opening is opened.

The parameter having a correlation with the saturated vapor pressure in the exhaust pipe is not limited to the coolant temperature THW. The exhaust gas temperature can be the parameter.

In the above embodiments, the air-fuel-ratio sensor 52 includes the sensor element 52a and the heater 52b. Alternatively, the heater can be arranged at a vicinity of the air-fuel-ratio sensor having the sensor element 52a.

An exhaust gas sensor detecting a property of the exhaust gas is not limited to the air-fuel-ratio sensor which detects air-fuel ratio based on the oxygen concentration and the unburned fuel concentration in the exhaust gas. For example, an air-fuel-ratio sensor which varies its output according to whether the air-fuel ratio is lean or rich relative to a predetermined air-fuel ratio can be employed.

The fuel is not limited to gasoline and alcohol. The present invention can be applied to any internal combustion engine which uses blended fuel at any rate.

The internal combustion engine is not limited to an intake port gasoline engine. A direct injection engine can be used. Furthermore, the engine is not limited to a gasoline engine. A diesel engine can be also used.

What is claimed is:

1. A controller for an internal combustion engine equipped with an exhaust gas sensor which detects a property of an exhaust gas, the exhaust gas sensor being activated by receiving a heat from a heating means, the controller comprising:
a concentration obtaining means for obtaining a concentration information with respect to a concentration of a specified component of a fuel; and
a set means for variably setting a heating start time of the heating means based on the concentration obtained by the concentration obtaining means.

2. A controller according to claim 1, wherein
the fuel includes at least one of gasoline and alcohol, and the specified component of the fuel is alcohol.

3. A controller according to claim 1, wherein
the concentration obtaining means estimates the concentration based on a parameter having a correlation with a fuel combustion in the internal combustion engine.

4. A controller according to claim 3, further comprising
a detecting means for detecting whether a fuel is supplied to a fuel tank, wherein
the set means sets the heating start time at or after a latest time which is variably set according to the concentration information obtained by the concentration obtaining means when it is determined that the fuel is supplied to the fuel tank after a last stop of the engine before a current start of the engine.

5. A controller according to claim 1, further comprising
a determination means for determining whether a reliable value can be used as the concentration information obtained by the concentration obtaining means, wherein
the set means sets the heating start time at or after a latest time which is variably set according to the concentration information obtained by the concentration obtaining means when the determination means determines that the reliable value can not be used.

6. A controller according to claim 1, wherein
the exhaust gas sensor detects an air-fuel ratio of the internal combustion engine based on a specified component of the exhaust gas.

7. A control system for an internal combustion engine, comprising:
a controller according to claim 1,
an exhaust gas sensor; and
a heating means for heating the exhaust gas sensor.
